(19) United States
(12) Patent Application Publication
(10) Pub. No.: US 2007/0116075 A1
(43) Pub. Date: May 24, 2007

(54) Laser diode driver

(75) Inventors: Yuuji Fujita, Shiga (JP); Makoto Sakaguchi, Shiga (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kanagawa (JP)

(21) Appl. No.: 11/594,724

(22) Filed: Nov. 9, 2006

(30) Foreign Application Priority Data
Nov. 22, 2005 (JP) 2005-336894

(51) Int. Cl. H01S 3/00; H02H 3/00

(52) U.S. Cl. 372/38.04; 361/82

(57) ABSTRACT

A laser diode driver includes a DC current source supplying DC current to a laser diode, a high frequency current source connected in parallel with the DC current source and supplying high frequency current to the laser diode. The laser diode driver further includes a circuit capable of changing the current of the DC current source when the high frequency current source is operating.

### BACKGROUND OF THE INVENTION

1. Field of the Invention

The present invention relates to a driver for a laser diode which is used as a light source for data reading, erasing, and writing on CD (Compact Disc), DVD (Digital Versatile Disc) and so on.

2. Description of Related Art

A laser diode which is used for an optical disc such as CD or DVD is driven using DC current in each of read, erase, and write periods as shown in FIG. 9 which illustrates a rewritable optical disc as an example. If the light from the laser diode is reflected on a disc surface to return to enter the laser diode, oscillation becomes unstable to cause noise to occur. To avoid this, as shown in FIG. 10, there is a technique of superposing high frequency current of several 100 MHz on DC current to change the oscillation mode of the laser diode from a single-mode to a multi-mode to thereby reduce the effect of noise. The superposition of the high frequency current is performed typically during the read period. It may be performed during the read and erase periods as shown in FIG. 10, or even during the write period. Further, the superposition of the high frequency current may be performed during a certain period only when focus servo or tracking servo becomes unstable. This is thus the essential feature for a laser diode driver.

A laser diode driver of a related art includes a first current source 60 that supplies DC current (e.g. 100 mA) to a laser diode LD, a second current source 61 that supplies high frequency current (e.g. 50 mA peak), and two NMOS transistors 62 and 63 that serve as switches to connect the current from the second current source 61 to either the laser diode LD or a dummy load 65 as shown in FIG. 11. In the circuit of FIG. 11, if voltage pulses SW1 and SW1′ with reverse phases to each other are applied to the gates of the NMOS transistors 62 and 63 as shown in FIGS. 12A and 12B, the current from the second current source 61 flows into the laser diode LD only when the NMOS transistor 62 is ON. Accordingly, a drive current I3 which flows to the laser diode LD has a waveform as shown in FIG. 12C, in which the high frequency current of 50 mA peak is added to the DC current of 100 mA. This is described in Japanese Unexamined Patent Application Publication No. 2001-237489.

Another laser diode driver of a related art includes a first current source 70 that supplies DC current to a laser diode LD, a second current source 71 that supplies high frequency current, two NMOS transistors 73 and 74 and two PMOS transistors 75 and 76 that respectively have the same channel width and constitute a current mirror as shown in FIG. 13. In the circuit of FIG. 13, if voltage pulses SW1 and SW1′ with reverse phases to each other are applied to the gates of the PMOS transistors 75 and 76 as shown in FIGS. 14A and 14B, when the PMOS transistor 76 is ON, current I4 which is equal to current I2 is output from the second current source 71 and then combined with current I1 from the first current source 70, so that the current of I1+I4=I1+I2 flows into the laser diode LD. At this time, the PMOS transistor 75, the NMOS transistors 73 and 74 are OFF. Then, when the PMOS transistor 75 turns ON, current I6 which is equal to the current I2 flows through the path from the second current source 71 through the PMOS transistor 75 and the NMOS transistor 73. Thus, current I5 which is equal to the current I2 flows also to the NMOS transistor 74, which forms the current mirror with the NMOS transistor 73. Accordingly, the current I5 is subtracted from the current I1 from the first current source 70, so that the current of I1−I5=I1−I2 flows into the laser diode LD. At this time, the PMOS transistor 76 is OFF. Therefore, as a result of applying the voltage pulses SW1 and SW1′ with reverse phases to each other to the gates of the PMOS transistors 75 and 76, the drive current I3 of the laser diode LD has a waveform as shown in FIG. 14C, in which the current I2 (e.g. 50 mA peak) from the second current source 71 is alternately added to or subtracted from the current I1 (e.g. 100 mA) from the first current source 70. This is described in Japanese Unexamined Patent Application Publication No. 2001-237489.

The laser diode drivers as shown in FIGS. 11 and 13, however, have common problems to be solved. The values of current which flow during each period shown in FIG. 9 are typically set such that read current<erase current<write current. However, as a result of the superposition of high frequency current on DC current, the peak of the current increases by the amount of the high frequency current. This causes the peak to exceed a prescribed threshold which is determined by the material of an optical disc or the characteristics of a laser diode, which may raise the drawback that erasing is performed during the read period, writing is performed during the erase period, or the like.

The laser diode drivers as shown in FIGS. 11 and 13 also have the drawback that the current consumption is large to cause excessive heating due to the presence of the current flowing from a DC current source and a high frequency current source, bypassing a laser diode LD, into a ground, e.g. the current flowing through the dummy load 65 in the laser diode driver of FIG. 11 and the current (I6) flowing through the NMOS transistor 73 and the current (I5) flowing through the NMOS transistor 74 in the laser diode driver of FIG. 13.

Accordingly, a laser diode driver which avoids erroneous operation that erasing is performed during the read period and writing is performed during the erase period or which enables low power consumption to maintain moderate heating is demanded.

### SUMMARY OF THE INVENTION

According to an aspect of the present invention, there is provided a laser diode driver including a DC current source supplying DC current to a laser diode, a high frequency current source connected in parallel with the DC current source and supplying high frequency current to the laser diode, and a circuit capable of changing current of the DC current source when the high frequency current source is operating.

According to another aspect of the present invention, a laser diode driver includes a high frequency current source supplying high frequency current to a laser diode and a DC current source supplying DC current to the laser diode. A current value of the DC current can be set differently between a superposition mode when the high frequency current is superposed and a non-superposition mode when the high frequency current is not superposed.

According to another aspect of the present invention, a laser diode driver includes a DC current source supplying DC current to a laser diode, a high frequency current source connected in parallel with the DC current source and supplying high frequency current to the laser diode, and a circuit capable of changing current of the DC current source in accordance with operation of the high frequency current source.

The laser diode driver of one aspect of the present invention does not have a path for the current supplied from the DC current source and the high frequency current source to flow except for the path from the power supply voltage to the ground through the laser diode, and there is no path which bypasses the laser diode.

The laser diode driver according to embodiments of the present invention includes a circuit for changing the current through a DC current source when a high frequency current source is operating, thereby controlling the peak value of the drive current of a laser diode to fall below a prescribed threshold which is determined by the material of an optical disc and the characteristics of the laser diode. This avoids erroneous operation of performing erasing during the read period, writing during the erase period, or the like. Further, there is no path from a power supply voltage to a ground by bypassing the laser diode, and therefore the current supplied from the DC current source and the high frequency current source cannot flow to the ground without passing through the laser diode. Accordingly, all of the current supplied from the DC current source and the high frequency current source contribute to the emission of the laser diode, thereby providing the advantage of preventing high power consumption and excessive heating.

### BRIEF DESCRIPTION OF THE DRAWINGS

The above and other objects, advantages and features of the present invention will be more apparent from the following description taken in conjunction with the accompanying drawings, in which:

FIG. 1 is a circuit block diagram showing a laser diode driver according to a first and a fourth embodiment of the present invention;

FIG. 2 is a detailed circuit diagram showing the laser diode driver according to the first embodiment;

FIGS. 3A to 3E are views showing the operation of the laser diode driver according to the first embodiment;

FIG. 4 is a circuit block diagram showing a laser diode driver according to a second and a third embodiment of the present invention;

FIG. 5 is a detailed circuit diagram showing of the laser diode driver according to the second embodiment;

FIGS. 6A to 6E are views showing the operation of the laser diode driver according to the second embodiment;

FIG. 7 is a detailed circuit diagram showing the laser diode driver according to the third embodiment;

FIG. 8 is a detailed circuit diagram showing an example of the laser diode driver according to the fourth embodiment;

FIG. 9 is a view to describe the drive current of a laser diode;

FIG. 10 is a view to describe the drive current of a laser diode onto which high frequency current is superposed;

FIG. 11 is a circuit diagram showing a laser diode driver according to a related art;

FIGS. 12A to 12C are views to describe the operation of a laser diode driver according to a related art;

FIG. 13 is a circuit diagram showing another laser diode driver according to a related art; and

FIGS. 14A to 14C are views to describe the operation of another laser diode driver according to a related art.

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

Exemplary embodiments of the present invention are described hereinafter with reference to the accompanying drawings. In the drawings, the same elements as those described in the related art are denoted by the same reference numerals.

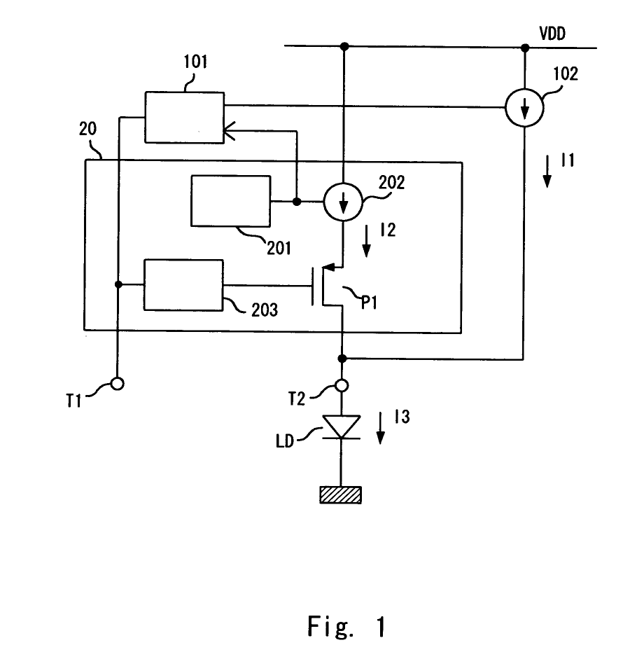

Referring first to FIG. 1, a laser diode driver according to a first embodiment of the present invention includes a DC current source 102, a first current setting circuit 101 for setting the current to the DC current source 102, and a high frequency superposing circuit 20. The high frequency superposing circuit 20 includes a high frequency current source 202, a second current setting circuit 201 for setting the current to the high frequency current source 202, and a superposition controller 203 for controlling a first switching element P1 and the superposition of high frequency current. In this embodiment, the output of the second current setting circuit 201 is input to the first current setting circuit 101, so that the current value of the DC current source 102 decreases by the amount proportional to the maximum current flowing through the high frequency current source 202 when high frequency current is superposed.

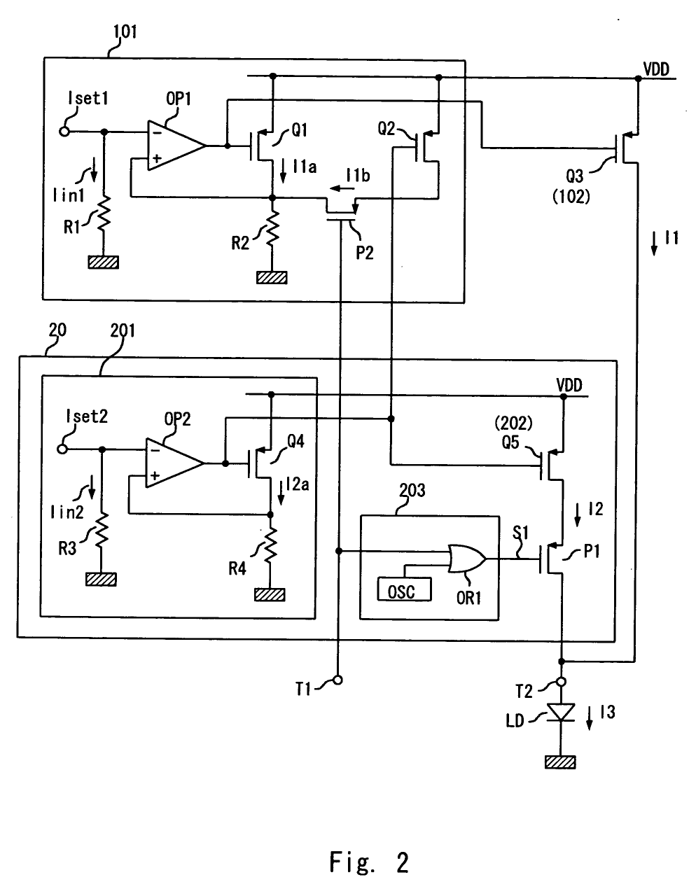

Referring next to FIG. 2 showing a detailed example of the circuit of FIG. 1, the configuration of the laser diode driver is described hereinafter. The PMOS transistor Q3 serves as the DC current source 102. The source and drain of the PMOS transistor Q3 are connected to a power supply voltage VDD and an output terminal T2, respectively. The first current setting circuit 101 includes an operational amplifier OP1. The inverting input terminal of the operational amplifier OP1 is connected to a current setting terminal Iset1 and one end of a resistor R1. The non-inverting input terminal of the operational amplifier OP1 is connected to the drain of a PMOS transistor Q1, one end of a resistor R2, and the drain of a second switching element P2. The output of the operational amplifier OP1 is connected to the gate of the PMOS transistor Q1 and the gate of the PMOS transistor Q3 as the DC current source 102. The other ends of the resistors R1 and R2 are grounded, the sources of the PMOS transistors Q1 and Q2 are connected to the power supply voltage VDD, and the drain of the PMOS transistor Q2 is connected to the source of the second switching element P2. The gate of the second switching element P2 is connected to a super position control terminal T1, and the gate of the PMOS transistor Q2 is connected to the output of the second current setting circuit 201.

The second current setting circuit 201 includes an operational amplifier OP2. The inverting input terminal of the operational amplifier OP2 is connected to a current setting terminal Iset2 and one end of a resistor R3. The non-inverting input terminal of the operational amplifier OP2 is connected to the drain of a PMOS transistor Q4 and one end of a resistor R4. The output of the operational amplifier OP2 is connected to the gate of a PMOS transistor Q4 and the gate of a PMOS transistor Q5 which serves as the high frequency current source 202. The other ends of the resistors R3 and R4 are grounded, and the source of the PMOS transistors Q4 is connected to the power supply voltage VDD.

The superposition controller 203 includes an oscillator OSC and an OR circuit OR1. One input terminal of the OR circuit OR1 is connected to the super position control terminal T1, and the other input terminal is connected to the output of the oscillator OSC. The output terminal of the OR circuit OR1 is connected to the gate of the first switching element P1.

The high frequency superposing circuit 20 includes the second current setting circuit 201 and the superposition controller 203. The source of the PMOS transistor Q5 as the high frequency current source 202 is connected to the power supply voltage VDD, and the drain is connected to the source of the first switching element P1. The drain of the first switching element P1 is connected to an output terminal T2. The output terminal T2 is connected to the anode of the laser diode LD which serves as a load. The cathode of the laser diode LD is grounded.

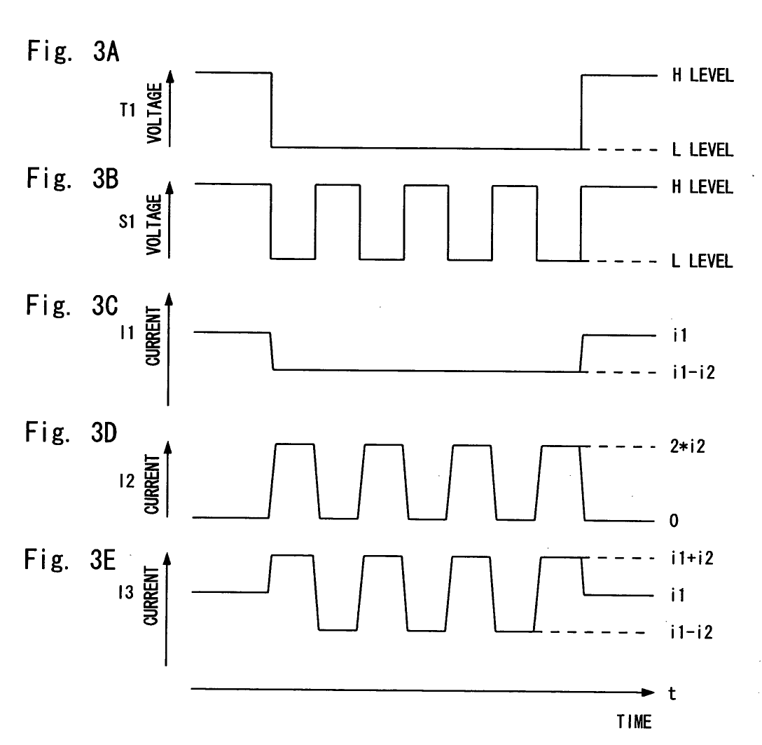

Referring then to FIGS. 2 and 3, the operation of the laser diode driver of this embodiment is described hereinbelow. When the superposition control terminal T1 is high level (hereinafter referred to as H level), the output S1 of the OR circuit OR1 is H level regardless of the output of the oscillator OSC, and the first switching element P1 formed of a PMOS transistor is OFF. Accordingly, the current from the high frequency current source 202 is blocked by the first switching element P1 and does not flow into the laser diode LD.

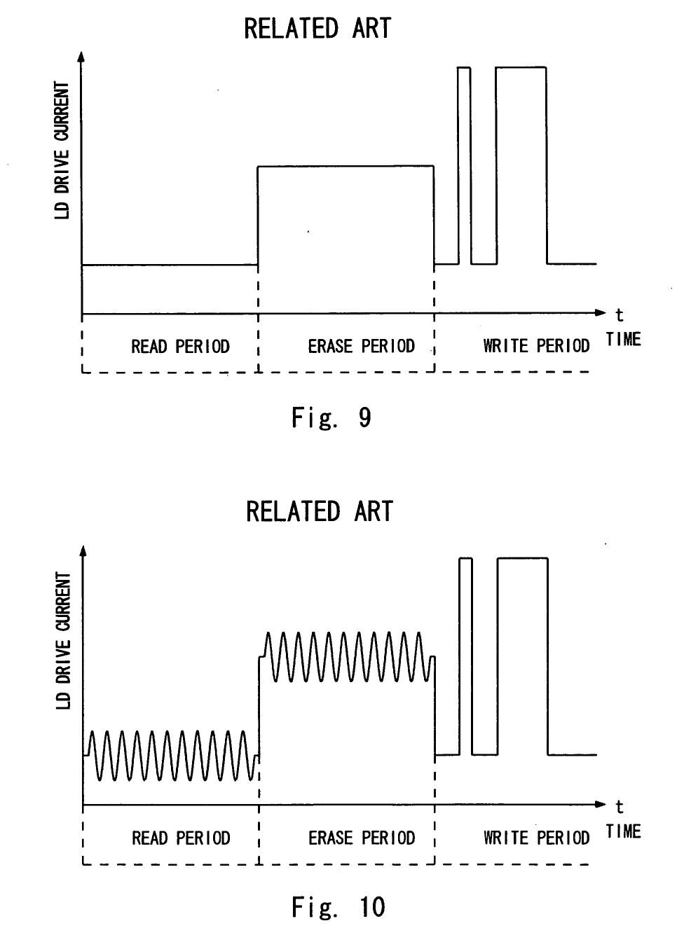

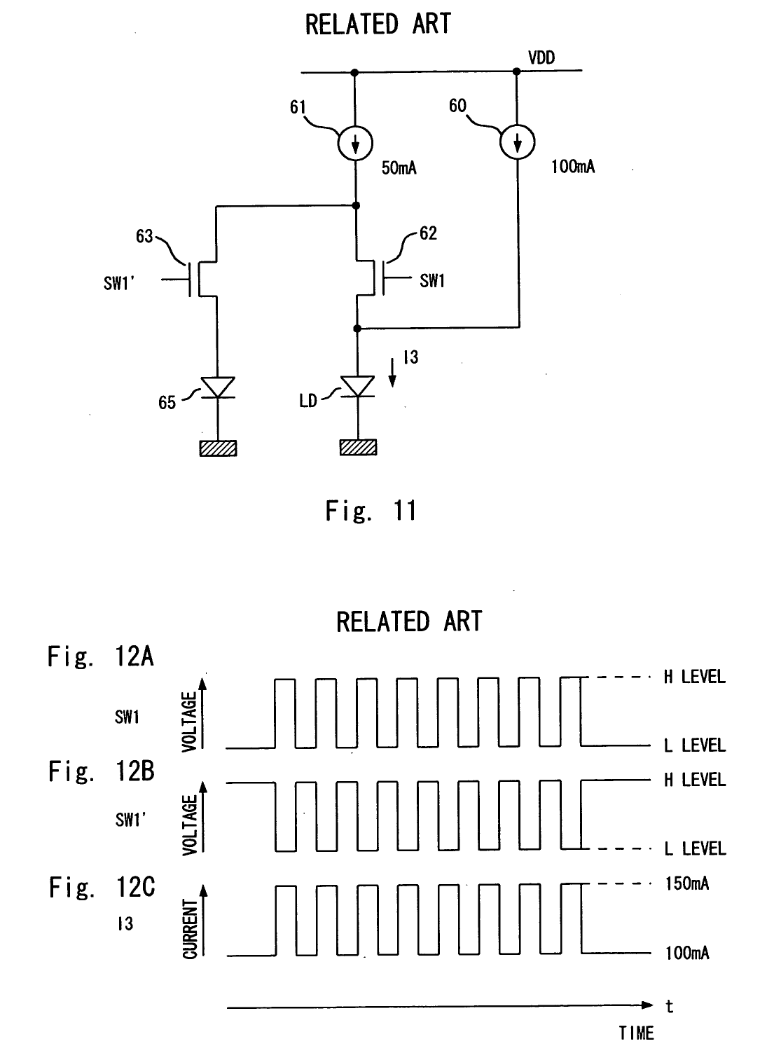

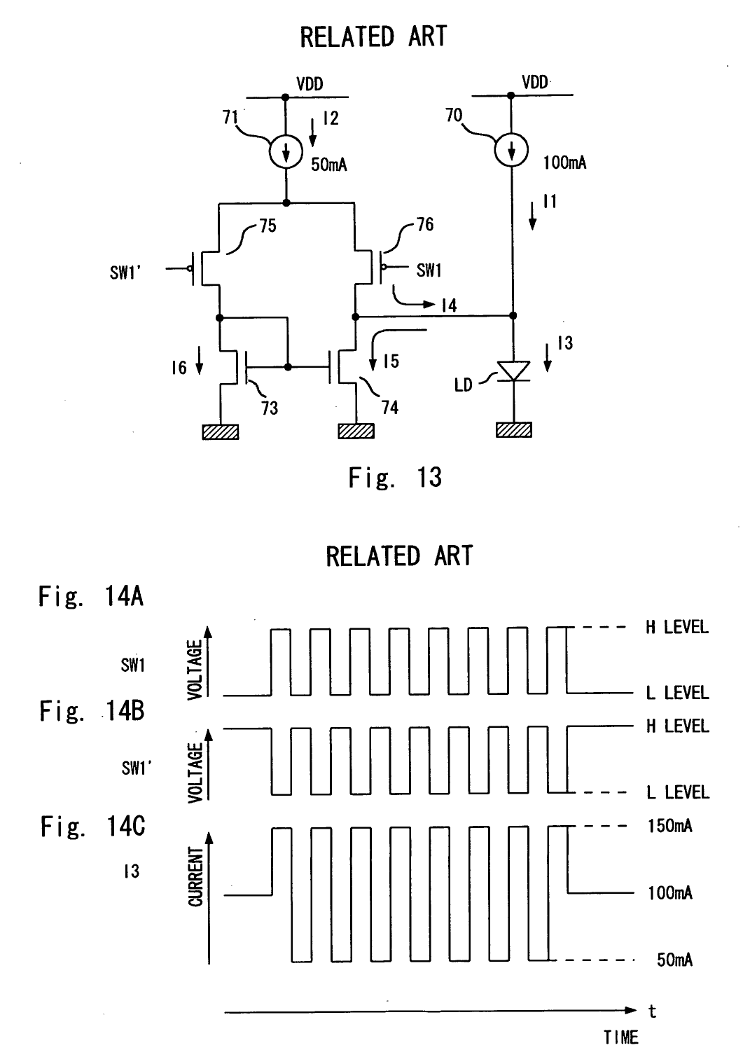

Further, when the superposition control terminal T1 is H level, the second switching element P2 formed of a PMOS transistor is OFF. If the current Iin1 is supplied from the current setting terminal Iset1 to the resistor R1, the current of I1a=(r1/r2)*Iin1 (where r1 and r2 indicate the resistance values of the resistors R1 and R2, respectively) flows through the drain of the PMOS transistor Q1. If the current ratio of the PMOS transistors Q1 and Q3 (102) is 1:m, the current of I1=m*I1a flows from the power supply voltage VDD through the PMOS transistor Q3 (102), the output terminal T2, and the laser diode LD into the ground, so that the current waveform without the superposition of high frequency current as described in FIG. 9 is obtained.

On the other hand, when the superposition control terminal T1 is low level (hereinafter referred to as L level), the output S1 of the OR circuit OR1 is H level or L level in accordance with the output of the oscillator OSC, and the first switching element P1 formed of a PMOS transistor turns ON or OFF. If the current Iin2 is supplied from the current setting terminal Iset2 to the resistor R3, the current of I2a=(r3/r4)*Iin2 (where r3 and r4 indicate the resistance values of the resistors R3 and R4, respectively) flows through the drain of the PMOS transistor Q4. If the current ratio of the PMOS transistors Q4 and Q5 (202) is 1:n, the current of I2=n*I2a flows from the power supply voltage VDD through the PMOS transistor Q5 (202), the first switching element P1, the output terminal T2, and the laser diode LD into the ground.

Further, when the superposition control terminal T1 is L level, the second switching element P2 formed of a PMOS transistor is ON, and the PMOS transistors Q1 and Q2 are such that the source and the drain are connected in parallel. If the current ratio of the PMOS transistors Q4 and Q2 is 1:n/2m, for example, because the current flowing through the PMOS transistor Q4 when the current of I2 is flowing through the PMOS transistor Q5 is I2/n, the current I1b flowing through the PMOS transistor Q2 is (n/2m)*(I2/n)=I2/2m. At this time, in order to keep a constant voltage to be applied to the non-inverting input terminal of the operational amplifier OP1, the current I1a flowing through the PMOS transistor Q1 decreases by I2/2m, and the current flowing though the DC current source 102 (Q3) decreases by m*(I2/2m)=I2/2.

The current waveform at this condition is described hereinafter with reference to FIGS. 3A to 3E. In FIGS. 3A to 3E, i1 indicates the current value which flows through the DC current source 102 (Q3) when superposition is not performed, and i2 indicates the average current value which flows through the high frequency current source 202 (Q5) where a duty ratio is assumed to be 1:1. When the superposition control terminal T1 changes from H level to L level as shown in FIG. 3A, the waveform of FIG. 3B is output as the output S1 of the OR circuit OR1. Further, the current I1 flowing through the DC current source 102 (Q3) changes from i1 to i1-i2 as shown in FIG. 3C. The current I2 flowing through the high frequency current source 202 (Q5) shown in FIG. 3D is superposed thereon, so that the laser diode drive current I3 has the waveform that the average current is i1 and the amplitude is 2*i2 as shown in FIG. 3E. After that, when the superposition control terminal T1 changes from L level back to H level, the current I1 to I3 return to the original states as shown in FIGS. 3C to 3E.

The case where the average current does not change before and after the high frequency superposition when the current ratio of the PMOS transistors Q4 and Q2 is 1:n/m is described above. By changing the current ratio of the PMOS transistors Q4 and Q2, the current value to reduce the DC current can be changed in proportion to the maximum current of the high frequency current. For example, if the current ratio is set to 1:2n/m, the current waveform in which the peak current during the high frequency superposition is the same as the current before the high frequency superposition can be obtained.

In the laser diode driver according to this embodiment, the output of the second current setting circuit is supplied to the first current setting circuit, so that the current value of the DC current source decreases by the amount proportional to the maximum current flowing through the high frequency current source during switching operation of the first switching element. This controls the peak value of the drive current of the laser diode to fall below a prescribed threshold which is determined by the material of an optical disc and the characteristics of the laser diode, thereby avoiding erroneous operation of performing erasing during the read period, writing during the erase period, or the like. Further, the laser diode driver does not have a path for the current supplied from the DC current source and the high frequency current source to flow except for the path from the power supply voltage through the laser diode to the ground, and there is no path which bypasses the laser diode. Accordingly, all of the current supplied from the DC current source and the high frequency current source contribute to the emission of the laser diode, thereby providing the advantage of preventing high power consumption and excessive heating.

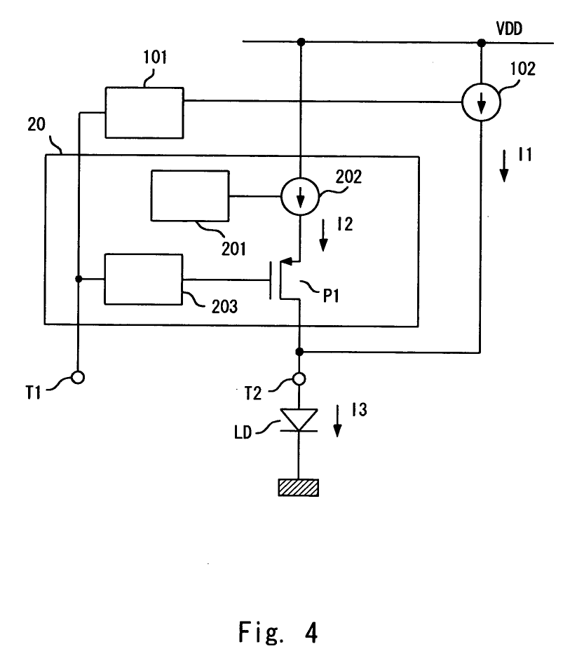

Referring now to FIG. 4, a laser diode driver according to a second embodiment of the present invention includes a DC current source 102, a first current setting circuit 101 for setting the current to the DC current source 102, and a high frequency superposing circuit 20. The high frequency superposing circuit 20 includes a high frequency current source 202, a second current setting circuit 201 for setting the current to the high frequency current source 202, and a superposition controller 203 for controlling a first switching element P1 and the superposition of high frequency current. In this embodiment, the output of the second current setting circuit 201 is not input to the first current setting circuit 101, so that the current value of the DC current source 102 decreases at a constant rate when high frequency current is superposed.

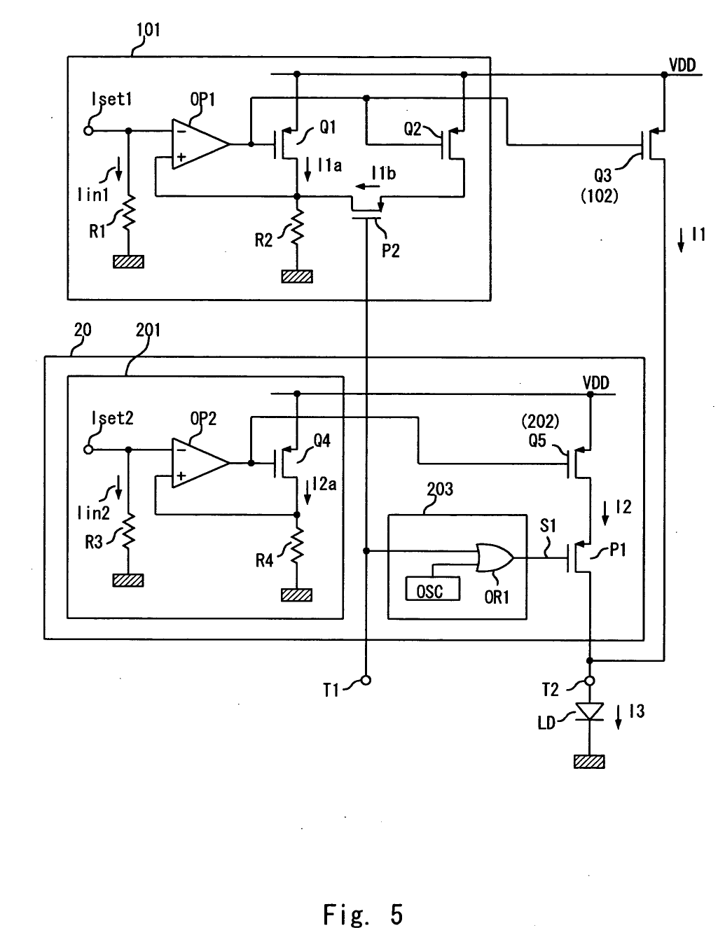

Referring then to FIG. 5 showing a detailed example of the circuit of FIG. 4, the configuration of the laser diode driver is described hereinafter. The laser diode driver according to the second embodiment has substantially the same configuration as the laser diode driver according to the first embodiment described above. However, the second embodiment is different from the first embodiment in that the gate of the PMOS transistor Q2 is connected to the output of the operational amplifier OP1 rather than the operational amplifier OP2.

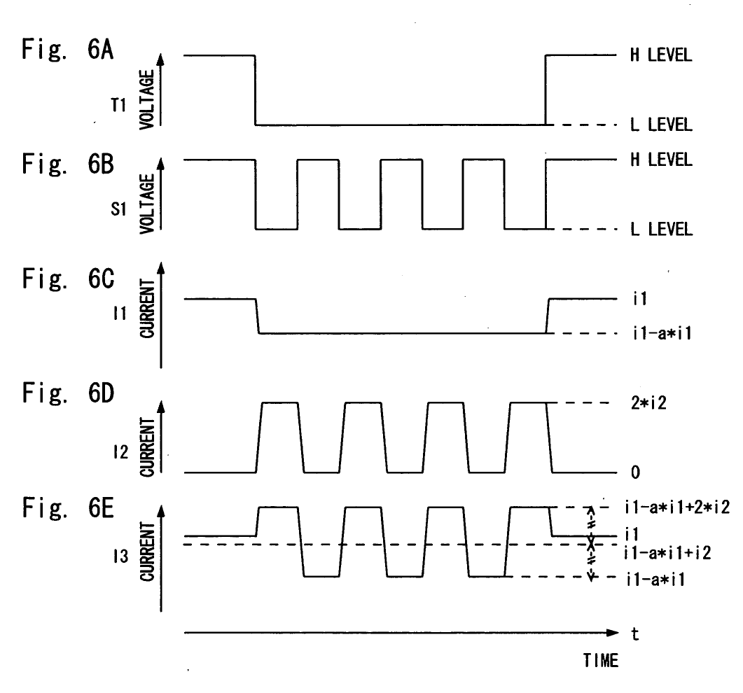

Referring further to FIGS. 5 and 6A to 6E, the operation of the laser diode driver of this embodiment is described hereinbelow. The operation when the superposition control terminal T1 is H level is the same as that in the laser diode driver of the first embodiment, and thus not described herein.

When the superposition control terminal T1 is L level, the current of I2=n*I2a flows from the power supply voltage VDD through the PMOS transistor Q5 (202), the first switching element P1, the output terminal T2, and the laser diode LD into the ground, which is the same as in the laser diode driver of the first embodiment.

When the superposition control terminal T1 is L level, the second switching element P2 formed of a PMOS transistor is ON, and the PMOS transistors Q1 and Q2 are such that the source and the drain are connected in common. If the current ratio of the PMOS transistors Q1 and Q2 is 1:a, for example, the current I1b flowing through the PMOS transistor Q2 is a*(I1/m). At this time, in order to keep a constant voltage to be applied to the non-inverting input terminal of the operational amplifier OP1, the current I1a flowing through the PMOS transistor Q1 decreases by a*(I1/m), and the current flowing though the DC current source 102 (Q3) decreases by m*a*(I1/m)=a*I1.

The current waveform at this condition is described hereinafter with reference to FIGS. 6A to 6E. In FIGS. 6A to 6E, i1 indicates the current value which flows through the DC current source 102 (Q3) when superposition is not performed, and i2 indicates the average current value which flows through the high frequency current source 202 (Q5) where a duty ratio is assumed to be 1:1. When the superposition control terminal T1 changes from H level to L level as shown in FIG. 6A, the waveform of FIG. 6B is output as the output S1 of the OR circuit OR1, and the current I1 flowing through the DC current source 102 (Q3) changes from i1 to i1−a*i1 as shown in FIG. 6C. The current I2 flowing through the high frequency current source 202 (Q5) shown in FIG. 6D is superposed thereon, so that the laser diode drive current I3 has the waveform that the average current is i1−a*i1+i2 and the amplitude is 2*i2 as shown in FIG. 6E. After that, when the superposition control terminal T1 changes from L level back to H level, the current I1 to I3 return to the original states as shown in FIGS. 6C to 6E.

As described in the foregoing, this embodiment enables the current ratio of the PMOS transistors Q1 and Q2 to be variable, thereby allowing the reduction of the DC current at a constant rate regardless of the high frequency current during the superposition of the high frequency current. For example, if the current ratio is set to 1:0.25, the DC current when the superposition of high frequency current is performed can decrease by 25% compared with when the superposition is not performed.

In the laser diode driver of this embodiment, the current value of the DC current source decreases at a constant rate during switching operation of the first switching element. This controls the peak value of the drive current of the laser diode to fall below a prescribed threshold which is determined by the material of an optical disc and the characteristics of the laser diode. This avoids erroneous operation of performing erasing during the read period, writing during the erase period, or the like. Further, all of the current supplied from the DC current source and the high frequency current source contribute to the emission of the laser diode as described in the laser diode driver of the first embodiment, thereby providing the advantage of preventing high power consumption and excessive heating.

A laser diode driver circuit according to a third embodiment of the present invention is composed of the same circuit blocks as those in the second embodiment described with reference to FIG. 4. In the third embodiment, however, the configuration of the first current setting circuit is different in such a way that the current value of the DC current value decreases by a constant value when the high frequency current is superposed.

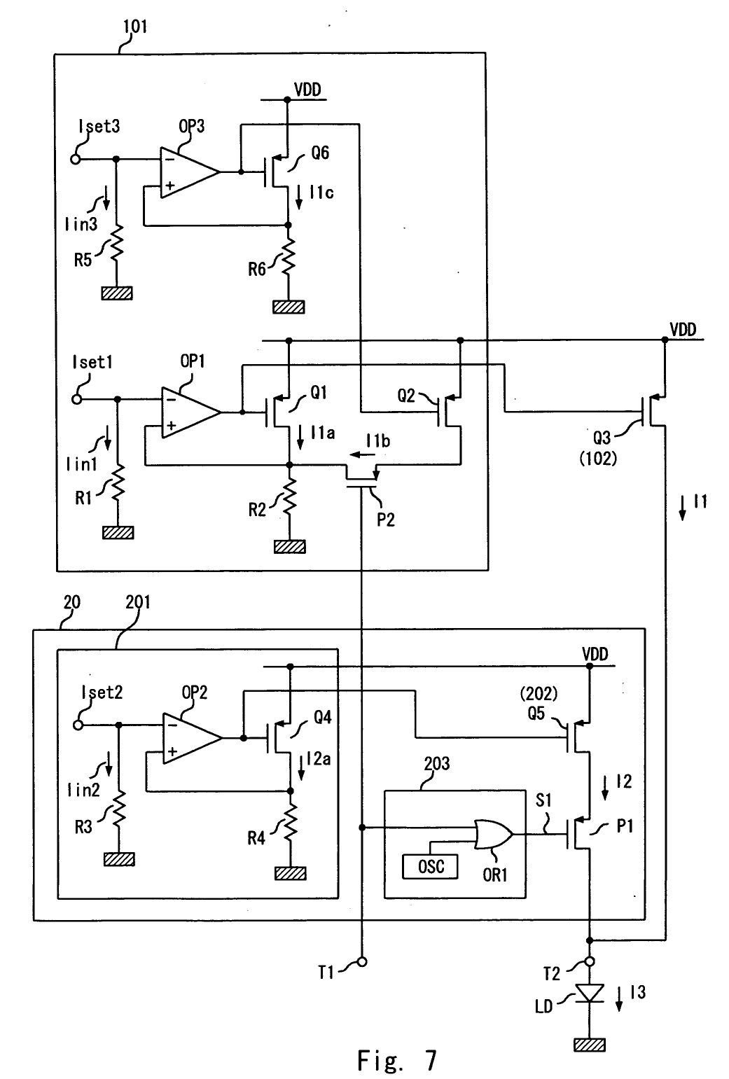

Referring then to FIG. 7 showing a detailed example of the circuit of the third embodiment, the configuration of the laser diode driver is described hereinafter. The laser diode driver according to the third embodiment is different from the laser diode driver according to the second embodiment only in the configuration of the first current setting circuit 101. Specifically, the first current setting circuit 101 of this embodiment further has an operational amplifier OP3 in addition to the components of the first current setting circuit in the laser diode driver of the second embodiment described above. The inverting input terminal of the operational amplifier OP3 is connected to a current setting terminal Iset3 and one end of a resistor R5, and the non-inverting input terminal of the operational amplifier OP3 is connected to the drain of a PMOS transistor Q6 and one end of a resistor R6. The output of the operational amplifier OP3 is connected to the gate of the PMOS transistor Q6 and the gate of the PMOS transistor Q2. The other ends of the resistors R5 and R6 are grounded, and the source of the PMOS transistor Q6 is connected to the power supply voltage VDD.

Referring further to FIG. 7, the operation of the laser diode driver of this embodiment is described hereinbelow. The operation when the superposition control terminal T1 is H level is the same as that in the laser diode driver of the first embodiment, and thus not described herein.

When the superposition control terminal T1 is L level, the current of I2=n*I2a flows from the power supply voltage VDD through the PMOS transistor Q5 (202), the first switching element P1, the output terminal T2, and the laser diode LD into the ground, which is the same as in the laser diode driver of the first embodiment.

When the superposition control terminal T1 is L level, the second switching element P2 formed of a PMOS transistor is ON, and the PMOS transistors Q1 and Q2 are such that the source and the drain are connected in parallel. If the current of Iin3 is supplied from the current setting terminal Iset3 to the resistor R5, the current of I1c=(r5/r6)*Iin3 (where r5 and r6 indicate the resistance values of the resistors R5 and R6, respectively) flows to the drain of the PMOS transistor Q6. If the current ratio of the PMOS transistors Q6 and Q2 is 1:b, for example, the current I1b flowing through the PMOS transistor Q2 is b*I1c. At this time, in order to keep a constant voltage to be applied to the non-inverting input terminal of the operational amplifier OP1, the current I1a flowing through the PMOS transistor Q1 decreases by b*I1c, and the current flowing though the DC current source 102 (Q3) decreases by m*b*I1c.

As described in the foregoing, this embodiment enables the current ratio of the PMOS transistors Q6 and Q2 to be variable, thereby allowing the reduction of the DC current always by a constant value regardless of the DC current I1 during non-superposition or the high frequency current I2 during the superposition of the high frequency current.

In the laser diode driver of this embodiment, the current value of the DC current source decreases by a constant value during switching operation of the first switching element. This controls the peak value of the drive current of the laser diode to fall below a prescribed threshold which is determined by the material of an optical disc and the characteristics of the laser diode. This avoids erroneous operation of performing erasing during the read period, writing during the erase period, or the like. Further, all of the current supplied from the DC current source and the high frequency current source contribute to the emission of the laser diode as described in the laser diode driver of the first embodiment, thereby providing the advantage of preventing high power consumption and excessive heating.

The laser diode driver according to the first to the third embodiment of the present invention may be selected appropriately in accordance with the design intention of an optical driver maker as a user of the laser diode driver.

A laser diode driver according to a fourth embodiment of the present invention is composed of the same circuit blocks as those in the first embodiment described with reference to FIG. 1. In the fourth embodiment, however, the configuration of the first current setting circuit is different in such a way that whether the current of the DC current source changes or not is selectable by an external signal when the high frequency current is superposed.

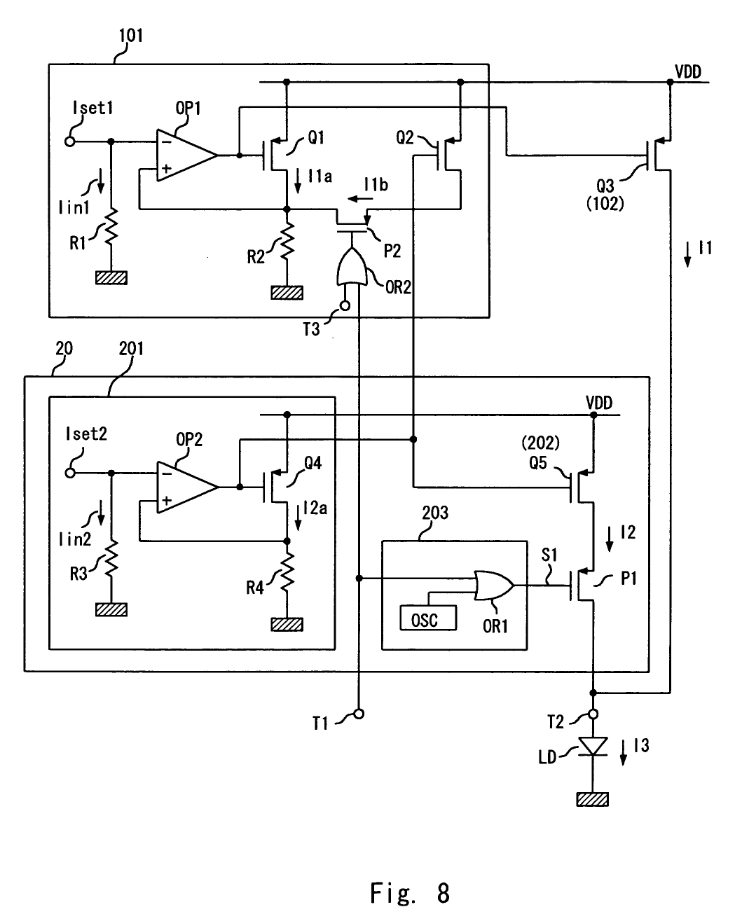

Referring then to FIG. 8 showing a detailed circuit example of the fourth embodiment, the configuration of the laser diode driver is described hereinafter. The laser diode driver according to the fourth embodiment is different from the laser diode driver according to the first embodiment only in the configuration of the first current setting circuit 101. Specifically, the first current setting circuit 101 of this embodiment further has an OR circuit OR2 in addition to the components of the first current setting circuit in the laser diode driver of the first embodiment described above. One input terminal of the OR circuit OR2 is connected to a DC current control terminal T3, and the other terminal is connected to the superposition control terminal T1. The output of the OR circuit OR2 is connected to the gate of the second switching element P2.

Referring further to FIG. 8, the operation of the laser diode driver of this embodiment is described hereinbelow. The operation when the superposition control terminal T1 is H level is the same as that in the laser diode driver of the first embodiment, and thus not described herein.

When the superposition control terminal T1 is L level, the current of I2=n*I2a flows from the power supply voltage VDD through the PMOS transistor Q5 (202), the first switching element P1, the output terminal T2, and the laser diode LD into the ground, which is the same as in the laser diode driver of the first embodiment.

If the superposition control terminal T1 is L level and the DC current control terminal T3 is also L level, the output of the OR circuit OR2 is L level, so that the second switching element P2 formed of a PMOS transistor is ON. Accordingly, the PMOS transistors Q1 and Q2 are such that the source and the drain are connected in parallel. In this condition, the current value of the DC current source decreases by the amount proportional to the maximum current flowing through the high frequency current source during the superposition of the high frequency current as in the laser diode driver of the first embodiment described above. On the other hand, when the DC current control terminal T3 is H level, the output of the OR circuit OR2 is H level, so that the second switching element P2 formed of a PMOS transistor is OFF. In this condition, the current value of the DC current source does not change during the superposition of the high frequency current.

In the laser diode driver of this embodiment, whether or not to change the current of the DC current source is selectable in accordance with the type of an optical disc by the level of an external signal which is applied to the DC current control terminal T3 when the high frequency current is superposed. This embodiment may be applied to the laser diode driver according to the second and third embodiments.

As described in the foregoing, the laser diode driver according to the embodiments of the present invention includes a circuit for changing the current through the DC current source when the high frequency current source is operating, thereby controlling the peak value of the drive current of the laser diode to fall below a prescribed threshold which is determined by the material of an optical disc and the characteristics of the laser diode. This avoids erroneous operation of performing erasing during the read period, writing during the erase period, or the like. Further, the laser diode driver does not have a path for the current supplied from the DC current source and the high frequency current source to flow except for the path from the power supply voltage through the laser diode to the ground, and there is no path which bypasses the laser diode. Accordingly, all of the current supplied from the DC current source and the high frequency current source contribute to the emission of the laser diode, thereby providing the advantage of preventing high power consumption and excessive heating.

Although the above embodiments are described in reference to the case where one DC current source and one high frequency current source are used, it is possible to switch between a plurality of DC current sources and a plurality of high frequency current sources for use in each of the read, erase and write periods. The laser diode driver according to different embodiments may be applied for each period.

Further, the above embodiments are described using a rewritable optical disc by way of illustration. However, the present invention may be applied to a write-once optical disc. In addition, it is possible to use the transistors with the conductivity types opposite to those described in the above embodiments or a logic circuit which operates in the same manner.

It is apparent that the present invention is not limited to the above embodiment and it may be modified and changed without departing from the scope and spirit of the invention.

What is claimed is:

1. A laser diode driver comprising:
a DC current source supplying DC current to a laser diode;
a high frequency current source connected in parallel with the DC current source and supplying high frequency current to the laser diode; and
a circuit capable of changing current of the DC current source when the high frequency current source is operating.

2. The laser diode driver according to claim 1, wherein current supplied from the high frequency current source always has the same current polarity as the DC current.

3. The laser diode driver according to claim 1, wherein current supplied from the DC current source and the high frequency current source flow through a path from a power supply voltage to a ground through the laser diode without bypassing the laser diode.

4. The laser diode driver according to claim 1, comprising:
a first current setting circuit setting a current value of the DC current source; a second current setting circuit setting a current value of the high frequency current source;
a first switching element switching current from the high frequency current source; and
a superposition controller supplying high frequency current to the first switching element,
wherein output of the second current setting circuit is supplied to the first current setting circuit such that the current value of the DC current source decreases by an amount proportional to maximum current flowing through the high frequency current source during switching operation of the first switching element.

5. The laser diode driver according to claim 4, wherein
the DC current source is formed of a MOS transistor controlled by output of the first current setting circuit,
the first current setting circuit includes a first transistor having a gate connected in common with the MOS transistor and controlling a current value of DC current flowing through the MOS transistor during non-switching operation of the first switching element, and a second transistor connected in parallel with the first transistor and controlling a current value of DC current flowing through the MOS transistor during switching operation of the first switching element to decrease from the current value during the non-switching operation, and
the second transistor is controlled by output of the second current setting circuit.

6. The laser diode driver according to claim 1, comprising:
a first current setting circuit setting a current value of the DC current source;
a second current setting circuit setting a current value of the high frequency current source;
a first switching element switching current from the high frequency current source; and
a superposition controller supplying high frequency current to the first switching element,
wherein the current value of the DC current source decreases at a constant rate during switching operation of the first switching element.

7. The laser diode driver according to claim 6, wherein
the DC current source is formed of a MOS transistor controlled by output of the first current setting circuit,
the first current setting circuit includes a first transistor having a gate connected in common with the MOS transistor and controlling a current value of DC current flowing through the MOS transistor during non-switching operation of the first switching element, and a second transistor connected in parallel with the first transistor and controlling a current value of DC current flowing through the MOS transistor during switching operation of the first switching element to decrease from the current value during the non-switching operation, and
the second transistor is controlled by a gate voltage of the first transistor.

8. The laser diode driver according to claim 1, comprising:
a first current setting circuit setting a current value of the DC current source;
a second current setting circuit setting a current value of the high frequency current source;
a first switching element switching current from the high frequency current source; and
a superposition controller supplying a high frequency current to the first switching element,
wherein output of the first current setting circuit is changed by a constant value during switching operation of the first switching element such that the current value of the DC current source decreases always by a constant value.

9. The laser diode driver according to claim 8, wherein
the DC current source is formed of a MOS transistor controlled by output of the first current setting circuit,
the first current setting circuit includes a first transistor having a gate connected in common with the MOS transistor and controlling a current value of DC current flowing through the MOS transistor during non-switching operation of the first switching element, a second transistor connected in parallel with the first transistor and controlling a current value of DC current flowing through the MOS transistor during switching operation of the first switching element to decrease from the current value during the non-switching operation, and a constant voltage output unit, and
the second transistor is controlled by output of the constant voltage output unit.

10. The laser diode driver according to claim 4, wherein whether the current of the DC current source changes or not is selectable by an external signal during switching operation of the first switching element.

11. The laser diode driver according to claim 10, wherein the first current setting circuit includes an OR circuit, one input of the OR circuit receiving the external signal, another input of the OR circuit receiving a superposition on/off signal input to the superposition controller, and output of the OR circuit supplied to a gate of the second switching element.

12. A laser diode driver comprising:
a high frequency current source supplying high frequency current to a laser diode;
a DC current source supplying DC current to the laser diode,
wherein a current value of the DC current can be set differently between a superposition mode when the high frequency current is superposed and a non-superposition mode when the high frequency current is not superposed.

13. The laser diode driver according to claim 12, wherein the high frequency current has one-sided polarity that is reverse to a direction of a change in a current value of the DC current from the non-superposition mode to the superposition mode.

14. The laser diode driver according to claim 13, wherein a current value of the DC current in the superposition mode is set smaller than a current value of the DC current in the non-superposition mode.

15. The laser diode driver according to claim 12, further comprising:
a first current setting circuit setting a current value of the DC current; and
a second current setting circuit setting a current value of the high frequency current,
wherein the first current setting circuit includes:
a first DC current setting unit setting a current value of DC current in the non-superposition mode; and
a second DC current setting unit setting a current value of DC current in the superposition mode.

16. The laser diode driver according to claim 15, wherein the second DC current setting unit includes a function to act on the first DC current setting unit in the superposition mode such that a current value of the DC current in the non-superposition mode decreases.

17. The laser diode driver according to claim 16, wherein the second DC current setting unit is controlled by output of the second DC current setting unit in the superposition mode such that a current value of the DC current decreases from a current value in the non-superposition mode by an amount proportional to a current value of the high frequency current.

18. The laser diode driver according to claim 16, wherein the second DC current setting unit is controlled by output of the first DC current setting unit in the superposition mode such that a current value of the DC current in the non-superposition mode decreases at a constant rate.

19. The laser diode driver according to claim 16, wherein
the first DC current setting unit includes a third DC current setting unit, and
the second DC current setting unit is controlled by output of the third DC current setting unit in the superposition mode such that a current value of the DC current in the non-superposition mode decreases always by a constant value.

20. A laser diode driver comprising:
a DC current source supplying DC current to a laser diode,
a high frequency current source connected in parallel with the DC current source and supplying high frequency current to the laser diode, and
a circuit capable of changing current of the DC current source in accordance with operation of the high frequency current source.
